(19) United States
(12) Patent Application Publication
(10) Pub. No.: US 2006/0181043 A1
(43) Pub. Date: Aug. 17, 2006

(54) Rotary cam alignment system

(76) Inventor: Michael L. Zebolsky, Marshall, MI (US)

Correspondence Address: DYKEMA GOSSETT PLLC;SUITE 300, 39577 WOODWARD AVENUE, BLOOMFIELD HILLS, MI, 48304, US

(21) Appl. No.: 11/059,015

(22) Filed: Feb. 16, 2005

(51) Int. Cl. B62D 17/00; B60G 9/00

(52) U.S. Cl. 280/86.75; 280/86.754; 280/124.116

(57) ABSTRACT

An improved system used for alignment of a vehicle suspension and axle includes a cam plate that is rotatable relative to one of two spaced plates of a hanger bracket about an axis of rotation extending through a center of the cam plate. An aperture in the cam plate is aligned with an elongated opening in the bracket plate and defines a cam surface. A bushing may be disposed in the aperture and ride on the cam surface. A fastener extends through the bushing, the elongated openings in the bracket plates, and the suspension control arm. Rotation of the cam plate and movement of the bushing and the fastener along the cam surface of the aperture displaces the fastener along the elongated openings of the bracket.

### BACKGROUND OF THE INVENTION

1. Field of the Invention

This invention relates to vehicle suspensions and, in particular, to a system used for alignment of a vehicle suspension and axle.

2. Disclosure of Related Art

In a conventional vehicle suspension system, a suspension control arm has a first end rigidly connected to an axle of the vehicle and a second end pivotally connected to a bracket descending from the vehicle frame. The second end of the control arm may terminate in a bushing. The bracket generally includes first and second spaced walls that receive the bushing therebetween. A fastener extends through the first wall of the bracket, through the bushing, and through the second wall of the bracket. The fastener may also extend through one or more washers disposed on either side of the bushing between the first and second walls of the bracket. A nut is used to secure the fastener in place relative to the bracket and the control arm pivots about the fastener.

Conventional suspension systems must be aligned in a fore-aft direction to adjust the fore-aft position of the axle relative to the vehicle frame and thereby align the wheels that are supported on the axle. Improper alignment may lead to premature tire wear among other problems. In most conventional suspension systems, alignment is achieved by moving the control arm relative to the bracket descending from the frame. Each of the spaced walls of the bracket generally includes an elongated slot having a major axis that is parallel to the longitudinal direction of the vehicle. The fastener upon which the control arm pivots is moved within these slots to cause corresponding movement in the suspension control arm and axle. In some conventional suspension systems, a weld collar is disposed about the fastener and the position of the collar is adjusted to move the fastener. The collar is then welded to the frame bracket once proper alignment is achieved. These conventional systems are disadvantageous because realignment of the suspension and axle requires removal of the existing welds and the installation of new welds-a process that requires a relatively large amount of time. In other conventional suspension systems, an eccentric cam is disposed about the fastener and the cam is guided by one or more guides on the frame bracket. Rotation of the cam causes displacement of the fastener within the slots of the frame bracket and thereby adjusts the alignment of the suspension and axle. Although these latter systems enable the suspension to be realigned in a relatively short period of time, the systems require additional components and machining of existing suspension components thereby increasing the cost, weight, and complexity of the suspension. These alignment systems may also have a relatively low load capacity that discourages their use with trailers and other high load vehicles.

The inventors herein have recognized a need for a vehicle suspension that will minimize or eliminate one or more of the above-mentioned deficiencies.

### SUMMARY OF THE INVENTION

The present invention provides a vehicle suspension and, in particular, a system used for alignment of a vehicle suspension and axle.

A suspension for a vehicle in accordance with the present invention includes a suspension control arm connected to an axle of the vehicle and having one end pivotally connected to a bracket extending from a frame of the vehicle. The bracket includes first and second plates spaced from one another and defining aligned, elongated openings. The inventive suspension further includes a first cam plate rotatable relative to the first plate of the bracket about an axis of rotation extending through a center of the first cam plate. The first cam plate defines an aperture aligned with the elongated opening in the first plate. The aperture defines a cam surface. A fastener extends through the aperture in the cam plate, the elongated openings in the first and second plates of the bracket, and the end of the suspension control arm. In one embodiment of the invention, the suspension further includes a bushing disposed within the aperture and in engagement with the cam surface and the fastener extends through the bushing. Rotation of the cam plate and movement of the fastener along the cam surface of the aperture in the cam plate displaces the fastener within the elongated openings in the first and second plates of the bracket.

A suspension in accordance with the present invention has several advantages as compared to conventional suspension systems. First, the inventive system does not require the installation or removal of welds during the alignment process and, therefore, requires less time for realignment of the suspension as compared to many conventional systems. Second, the use of a bushing in one embodiment of the inventive system increases the load capacity of the alignment mechanism. Third, the inventive system is lightweight and uses simple, low-cost methods to manufacture components of the inventive system. As a result, the inventive system weighs less than most conventional systems and is less costly.

These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a side plan view of a vehicle suspension in accordance with the present invention.

FIG. 2 is an exploded perspective view of a portion of the suspension of FIG. 1 in accordance with a first embodiment of the invention.

FIG. 3 is an exploded perspective view of a portion of the suspension in FIG. 1 in accordance with a second embodiment of the invention.

### DETAILED DESCRIPTION OF THE PREFERRED EMBODIMENT

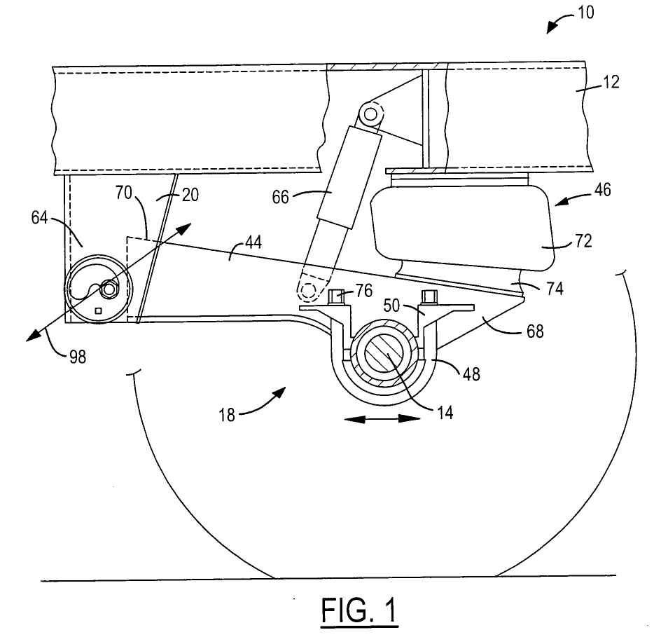

Referring now to the drawings wherein like reference numerals are used to identify identical components in the various views, FIG. 1 illustrates a portion of a vehicle 10. Vehicle 10 may include a frame 12, one or more axles 14, wheels 16, and a suspension 18 in accordance with the present invention. In the illustrated embodiment, vehicle 10 comprises a semi-trailer. It should be understood, however, that the present invention may find application in a wide variety of vehicles.

Frame 12 provides structural support to the body of vehicle 10. Frame 12 is conventional in the art and may be made from conventional metals and metal alloys such as steel. Frame 12 may include a pair of longitudinal rails (only one of which is shown in FIG. 1) and cross-members as is conventional in the art. Frame 12 may also include a plurality of mounting brackets, such as bracket 20, for mounting various components of vehicle 10 including suspension 18.

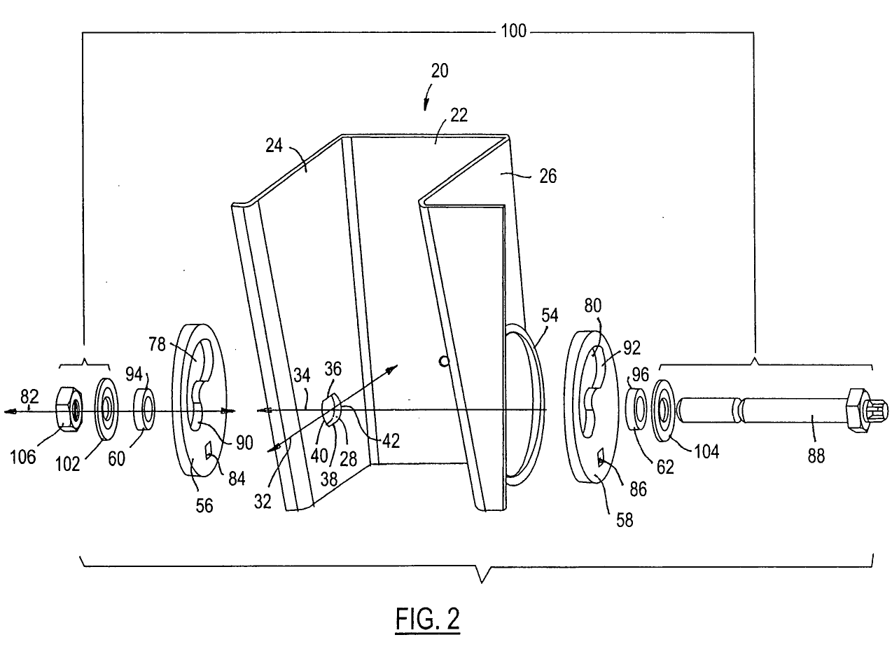

Referring to FIG. 2, bracket 20 will be described in greater detail. Bracket 20 is provided to pivotally mount suspension 18 to frame 12 and is conventional in the art. Bracket 20 includes a center plate 22 and a pair of inboard and outboard spaced side plates 24, 26 and may be welded to or integral with frame 12. Side plates 24, 26 include aligned, elongated slots 28, 30 that enable fore-aft alignment of suspension 18 and axle 14. Slots 28, 30 each have a major axis 32 that is generally parallel to the longitudinal direction of vehicle 10 and a minor axis 34 that is generally perpendicular to the longitudinal direction of vehicle 10 (only one set of axes being illustrated in FIG. 2). Each of slots 28, 30 may have a flat portion 36, 38 on either side of major axis 32 and a curved portion 40, 42 on either side of minor axis 34.

Referring again to FIG. 1, axle 14 is provided to support frame 12 on wheels 16 and also provides mounting surfaces for various suspension and brake components. Axle 14 is conventional in the art and may be made from conventional metals and metal alloys such as steel. Axle 14 extends in a transverse direction relative to vehicle 10 and may support one or more wheels 16 on each end.

Wheels 16 are provided to support vehicle 10 and are also conventional in the art. Wheels 16 are supported for rotation on each end of axle 14 and include tires mounted thereon.

Suspension 18 is provided to couple axle 14 to frame 12 and to allow for movement of axle 14 relative to frame 12. In the illustrated embodiment only one suspension assembly is shown. It should be understood, however, that a similar assembly may be disposed at the opposite end of axle 14 on the other side of vehicle 10. Suspension 18 may include a control arm 44, a spring assembly 46, and means, such as U-bolt 48 and bracket 50, for mounting arm 44 to axle 14. Suspension 18 may also include retainer rings 52, 54, a pair of cam plates 56, 58, a pair of bushings 60, 62, and means, such as mounting assembly 64, for pivotally mounting arm 44 to frame 12. It will be understood that suspension 18 may also include other conventional suspension elements, such as shock absorber 66, that are not described in detail herein.

Control arm 44 provides a structural framework for suspension 18 and movably couples axle 14 to frame 12. Arm 44 is conventional in the art and may be made from conventional metals and metal alloys such as steel. In the illustrated embodiment, arm 44 comprises a conventional overslung trailing arm construction. It should be understood by those in the art, however, that the inventive alignment device may be used in suspensions having a wide variety of control arms. One end 68 of arm 44 (the rearward end in the illustrated embodiment) may provide a mounting surface for spring assembly 46. Another end 70 of arm 44 (the forward end in the illustrated embodiment) is received within side plates 24, 26 of bracket 20 and is pivotally mounted to bracket 20 by mounting assembly 64, as described in greater detail hereinbelow.

Spring assembly 46 is provided to dampen movement of frame 12 responsive to variations in the surface over which vehicle 10 is traveling. Spring assembly 46 is conventional in the art. In the illustrated embodiment, assembly 46 comprises a conventional air spring 72 incorporating a piston 74 that controls air pressure within spring 72. Piston 74 is mounted to end 68 of arm 44 in abutting relation with spring 72. It should be understood by those in the art that a variety of known configurations for air or mechanical springs could be used without departing from the spirit of the present invention.

U-bolt 48 and bracket 50 are provided to fixedly couple control arm 44 to axle 14 and are conventional in the art. U-bolt 48 is disposed about axle 14 and its ends are received in bracket 50 and secured thereto using nuts 76. Bracket 50 may be welded to arm 44 or integral with arm 44. It should be understood by those in the art that arm 44 may be coupled to axle 14 in a variety of ways without departing from the spirit of the present invention. For example arm 44 may be welded to axle 14 or may be coupled to axle 14 using a variety of clamps that are disposed about axle 14 and coupled together.

Referring to FIG. 2, retainer rings 52, 54 are configured to received cam plates 56, 58 and allow for rotation of cam plates 56, 58 within retainer rings 52, 54. Retainer rings 52, 54 are generally circular in shape and may be made from conventional metals and metal alloys such as steel. Retainer rings 52, 54 may be fixed to side plates 24 and 26 of bracket 20 through welds, adhesives, bolts or other fasteners. In particular, retainer ring 52 may be disposed on an inboard side (relative to the vehicle) of inboard side plate 24 of bracket 20, and retainer ring 54 may be disposed on an outboard side of outboard side plate 26 of bracket 20. Retainer rings 52, 54 may be specifically located in relation to slots 28, 30. In particular, retainer rings 52, 54 may be located so as to enable placement of cam plates 56, 58 such that the apertures 78, 80 in cam plates 56, 58 may at least partially align with slots 28, 30 in bracket 20 during rotation of cam plates 56, 58. The components of the inventive rotary cam alignment system, including retainer rings 52, 54 are manufactured using simple low cost methods. For example, retainer rings 52, 54 may be comprised of coil stock and may be stamped during the same operation as cam plates 56, 58. The retainer rings 52, 54 may also be laser cut if a smaller quantity is desired.

Cam plates 56, 58 are each provided to function as a suspension alignment device. Cam plate 56 may be disposed on an inboard side (relative to the vehicle) of inboard side plate 24 of bracket 20. Cam plate 58 may be disposed on an outboard side of outboard side wall 26 of bracket 20. Cam plates 56, 58 may be disposed within retainer rings 52, 54. Cam plates 56, 58 may be generally circular in shape. Cam plates 56, 58 may be rotatable within retainer rings 52, 54 relative to bracket plates 24, 26 about an axis of rotation 82 extending through the center of the cam plates 56, 58. Cam plates 56, 58 may be made from conventional metals and metal alloys such as steel. In accordance with the low cost manufacturing methods of system components, cam plates 56, 58 may be stamped or laser cut depending on the required quantity of components desired. Cam plates 56, 58 define apertures 78, 80 and may define recesses 84, 86 for purposes described hereinbelow.

Apertures 78,80 are provided to allow movement of fastener 88 (to be described in detail further below) together with openings 28, 30 in a fore and aft direction enabling alignment of the suspension 18. Aperture 78, 80 may also act as a stop in the fore and aft direction due to friction along the aperture 78, 80, thereby improving the load capacity of the system. Apertures 78, 80 may be aligned with slots 28, 30 in side plates 24, 26 of bracket 20. Apertures 78, 80 are eccentric (relative to the center axis 82 of the plates). In the illustrated embodiment, apertures 78, 80 are substantially kidney shaped and have an involute profile. However, it is understood by those of ordinary skill in the art that apertures 78, 80 may take various shapes (preferably having a decreasing radius) and remain within the spirit and scope of the invention.

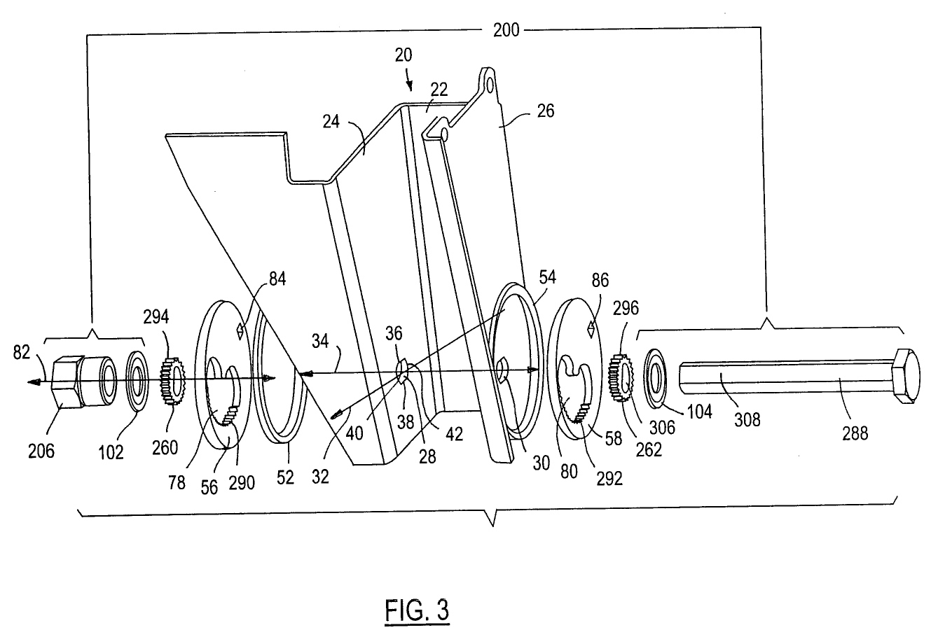

Apertures 78, 80 may each define a cam surface 90, 92 over which fastener 88 moves. Cam surfaces 90, 92 may be smooth as illustrated in the embodiment shown in FIG. 2. Referring now to FIG. 3, in accordance with a second embodiment of the invention, at least a portion of one or both of the cam surfaces 290, 292 may have a plurality of teeth.

Recesses 84, 86 are provided for engagement by a tool (not shown) for rotating cam plates 56, 58. Recesses 84, 86 may be generally rectangular in shape, although those of ordinary skill in the art will recognize that various other shapes remain within the spirit and scope of the invention. It should also be understood that a variety of structures may be provided to allow engagement of cam plates 56, 58 by conventional tools. For example, a plurality of recesses may be configured to receive a tool for rotation of cam plates 56, 58 to enable alignment of the vehicle suspension 18. Cam plates 56, 58 may alternatively include a flange configured for engagement by a tool for rotation of cam plates 56, 58 to enable alignment of the vehicle suspension 18. In an exemplary embodiment, a tool, such as a ratchet or breaker bar, may engage recess 84, 86 in order to rotate cam plates 56, 58. Rotation of cam plates 56, 58 causes movement of fastener 88 along the cam surfaces 90, 92 of apertures 78, 80. Fastener 88 is thereby forced to travel fore or aft, depending upon the rotation direction, within apertures 78, 80 and accordingly, slots 28, 30 of bracket 20. Apertures 78, 80 provide for fore-aft travel of the fastener 88 linearly proportional to the rotation angle of cam plate 56, 58. The rotation of cam plates 56, 58 enables proper alignment of the suspension 18.

Bushings 60, 62 are provided to transfer and absorb load, thereby contributing to the improved load capacity of the rotary cam alignment system. Bushings 60, 62 may be disposed within apertures 78, 80 in cam plates 56, 58. Bushings 60, 62 may be in engagement with cam surfaces 90, 92. Referring now to FIG. 2, in accordance with one embodiment of the inventive suspension, the outer surfaces 94, 96 of bushings 60, 62 are smooth. Referring now to FIG. 3, in an alternate embodiment, the outer surfaces 294, 296 of bushings 260, 262 have a plurality of teeth configured to engage teeth on cam surfaces 290, 292. Referring again to FIG. 3, bushings 260, 262 may include a radially inner surface that defines a flat 306. A corresponding flat 308 may be defined in a radially outer surface of fastener 288 in order to allow relative axial motion of fastener 288 during assembly, but prevent relative rotation of fastener 288 and bushings 260, 262.

Referring now to FIG. 1, mounting assembly 64 is provided to couple suspension 18 to frame 12 and to allow pivotal motion of end 70 of control arm 44 about an axis 98 extending transverse to the longitudinal direction of vehicle 10. Mounting assembly 64 may include a bushing (not shown) and a fastener assembly 100.

The bushing is provided to allow rotation of arm 44 about a fastener 88 of fastener assembly 100. The bushing is conventional in the art and is generally affixed to, or disposed within, end 70 of control arm 44. The bushing may include a sleeve that may be made from metal or metal alloys and further may include an elastomeric material such as rubber disposed about the sleeve. The bushing may also include a housing disposed radially outwardly of the metal sleeve and elastomeric material. The sleeve of the bushing may include a throughbore that is sized to receive a fastener 88 of assembly 100. The sleeve may define a boss at either end that extends outwardly from the bushing.

Fastener assembly 100 is provided to secure end 70 of control arm 44 to bracket 20. Assembly 100 may include a fastener 88, washers 102, 104, and a nut 106. Fastener 88 may comprise a screw, bolt, pin, or other conventional fastener. Fastener 88 extends through bushing 62, through aperture 80 in cam plate 58, through slot 30 in side plate 26 of bracket 20, through end 70 of suspension control arm 44, through slot 28 in side plate 24 of bracket 20, through aperture 78 in cam plate 56, and through bushing 60. Once the proper predetermined position has been established for the fastener 88 in slots 28, 30, fastener 88 may then be secured in place using washers 102, 104 and nut 106 in a conventional manner. Rotation of either cam plate 56, 58 causes a corresponding movement of the bushings 60, 62 and fastener 88 along the cam surfaces 90, 92 of the apertures 78, 80 in the cam plates 56, 58. This action displaces fastener 88 within the apertures 78, 80 in cam plates 56, 58 and also moves fastener 88 in a fore-aft direction within the elongated openings 28, 30 in the bracket side walls 24, 26. Referring now to FIG. 3, fastener assembly 200 is substantially similar to fastener assembly 100 with the modification to fastener 288, including flat 308, and a modification to nut 206.

Referring to FIGS. 1-3, a method for aligning a vehicle suspension 18 and axle 14 in accordance with the present invention will be described. The method includes the step of providing a suspension control arm 44 connected to the axle 14 of the vehicle 10 and having an end pivotally connected to a bracket 20 extending from a frame 12 of the vehicle 10. The bracket 20 includes first and second plates 24, 26 spaced from one another and defining aligned elongated openings 28, 30. The method further includes the step of providing a cam plate 56 configured for rotation relative to the bracket 20 about an axis 82 extending through a center of the cam plate 56 with the cam plate 56 defining an aperture 78 aligned with the elongated opening 28 in the plate 28 of bracket 20. The aperture 78 defines a cam surface 90. The method further includes the steps of providing a bushing 60 in engagement with the cam surface 92 and providing a fastener 88 extending through the bushing 60, the elongated openings 28, 30 in the plates 24, 26 of the bracket 20 and the end of the suspension control arm 44. Finally, the method includes the step of rotating the cam plate 56 and moving the bushing 60 and the fastener 88 along the cam surface 92 of the aperture 78 in the cam plate 56 to displace the fastener 88 along the elongated openings 28, 30 in the plates 24, 26 of the bracket 20. This step may include the substep of inserting a tool into a recess 84 in the cam plate 56. This rotation causes fore-aft movement of fastener 88 within apertures 78 of cam plates 56 and slots 28 of side plate 24 of bracket 20, thereby aligning suspension 18 and axle 14.

A suspension 18 and rotary cam alignment system in accordance with the present invention represents a significant improvement as compared to conventional suspension systems. First, the inventive system does not require the installation or removal of welds during the alignment process and, therefore, requires less time for realignment of the suspension as compared to many conventional systems. Second, the use of a bushing in the inventive system increases the load capacity of the alignment mechanism. Third, the inventive system is lightweight and uses simple, low-cost methods to manufacture components of the inventive system. As a result, the inventive system weighs less than most conventional systems and is less costly.

While the invention has been particularly shown and described with reference to the preferred embodiments thereof, it is well understood by those skilled in the art that various changes and modifications can be made in the invention without departing from the spirit and scope of the invention.

We claim:

1. A vehicle suspension, comprising:
a suspension control arm connected to an axle of said vehicle and having an end pivotally connected to a bracket extending from a frame of said vehicle, said bracket including first and second plates spaced from one another and defining aligned, elongated openings;
a first cam plate rotatable relative to said first plate of said bracket about an axis of rotation extending through a center of said first cam plate, said first cam plate defining an aperture aligned with said elongated opening in said first plate, said aperture defining a cam surface; and,
a fastener extending through said aperture in said cam plate and said elongated openings in said first and second plates of said bracket, and said end of said suspension control arm
wherein rotation of said first cam plate and movement of said fastener along said cam surface of said aperture in said first cam plate displaces said fastener along said elongated openings in said first and second plates of said bracket.

2. The suspension of claim 1 wherein said aperture of said first cam plate is an involute curve.

3. The suspension of claim 1 wherein said first cam plate includes a recess configured to receive a tool for rotation of said first cam plate to thereby allow alignment of said vehicle suspension.

4. The suspension of claim 1 further comprising a first retainer ring fixed to said first plate of said bracket, said first retainer ring configured to receive said first cam plate.

5. The suspension of claim 1 further comprising a second cam plate rotatable relative to said second plate of said bracket about an axis of rotation extending through a center of said second cam plate, said second cam plate defining an aperture aligned with said elongated opening in said second plate, said aperture defining a cam surface.

6. The suspension of claim 5 further comprising first and second retainer rings fixed to said first and second plate, respectively, of said bracket, said first and second retainer rings configured to receive said first and second cam plates, respectively.

7. The suspension of claim 1 wherein said cam surface is smooth.

8. The suspension of claim 1 wherein said cam surface includes a plurality of teeth.

9. A vehicle suspension, comprising:
a suspension control arm connected to an axle of said vehicle and having an end pivotally connected to a bracket extending from a frame of said vehicle, said bracket including first and second plates spaced from one another and defining aligned, elongated openings;
a first cam plate rotatable relative to said first plate of said bracket about an axis of rotation extending through a center of said first cam plate, said first cam plate defining an aperture aligned with said elongated opening in said first plate, said aperture defining a cam surface;
a bushing disposed within said aperture and in engagement with said cam surface; and,
a fastener extending through said bushing and said elongated openings in said first and second plates of said bracket, and said end of said suspension control arm
wherein rotation of said first cam plate and movement of said bushing and said fastener along said cam surface of said aperture in said first cam plate displaces said fastener along said elongated openings in said first and second plates of said bracket.

10. The suspension of claim 9 wherein said aperture of said first cam plate is an involute curve.

11. The suspension of claim 9 wherein said first cam plate includes a recess configured to receive a tool for rotation of said first cam plate to thereby allow alignment of said vehicle suspension.

12. The suspension of claim 9 further comprising a first retainer ring fixed to said first plate of said bracket, said first retainer ring configured to receive said first cam plate.

13. The suspension of claim 9 further comprising a second cam plate rotatable relative to said second plate of said bracket about an axis of rotation extending through a center of said second cam plate, said second cam plate defining an aperture aligned with said elongated opening in said second plate, said aperture defining a cam surface.

14. The suspension of claim 13 further comprising first and second retainer rings fixed to said first and second plate, respectively, of said bracket, said first and second retainer rings configured to receive said first and second cam plates, respectively.

15. The suspension of claim 9 wherein said cam surface is smooth.

16. The suspension of claim 9 wherein said cam surface includes a plurality of teeth.

17. The suspension of claim 9 wherein a radially outer surface of said bushing is smooth.

18. The suspension of claim 9 wherein a radially outer surface of said bushing includes a plurality of teeth.

19. The suspension of claim 1 wherein a radially inner surface of said bushing and a radially outer surface of said fastener define complementary flats.

20. A method for aligning a vehicle suspension and axle, comprising the steps of:
providing a suspension control arm connected to said axle of said vehicle and having an end pivotally connected to a bracket extending from a frame of said vehicle, said bracket including first and second plates spaced from one another and defining aligned, elongated openings;
providing a cam plate configured for rotation relative to said bracket about an axis extending through a center of said cam plate, said cam plate defining an aperture aligned with said elongated opening in said first plate, said aperture defining a cam surface;
providing a bushing in said aperture and in engagement with said cam surface;
providing a fastener extending through said bushing, said elongated openings in said first and second plates of said bracket, and said end of said suspension control arm; and,
rotating said cam plate while moving said bushing and said fastener along said cam surface of said aperture in said cam plate causing displacement of said fastener along said elongated openings in said first and second plates of said bracket.
